(19) United States
(12) Patent Application Publication
(10) Pub. No.: US 2003/0113145 A1
(43) Pub. Date: Jun. 19, 2003

(54) Drum cleaner with shock absorber

(75) Inventor: Futoshi Okabayashi, Kato-gun (JP)

Correspondence Address: ARMSTRONG,WESTERMAN & HATTORI, LLP, 1725 K STREET, NW, SUITE 1000, WASHINGTON, DC, 20006, US

(73) Assignee: Fujitsu Limited, Kawasaki (JP)

(21) Appl. No.: 10/143,940

(22) Filed: May 14, 2002

(30) Foreign Application Priority Data
Dec. 19, 2001 (JP) 2001-386019

(51) Int. Cl. G03G 21/00

(52) U.S. Cl. 399/350

(57) ABSTRACT

A drum cleaner is provided for removing unnecessary toner clinging to a photosensitive drum. The cleaner includes an arm rotatable about the prescribed axis, a cleaning blade fixed to the arm and held in contact with the drum, a bias spring connected to the arm for holding the cleaning blade in pressing contact with drum, and an arm restrainer that prevents the positional deviation of the arm that would otherwise result from fluctuation in the frictional force between the cleaning blade and the drum.

### BACKGROUND OF THE INVENTION

1. Field of the Invention

The present invention relates to a drum cleaner for removing unnecessary toner clinging to the surface of the photosensitive drum of an electrophotographic apparatus.

2. Description of the Related Art

An electrophotographic apparatus is generally constructed such that printing is performed by forming an electrostatic latent image on the surface of a rotating photosensitive drum, causing toner to adhere to this electrostatic latent image, and transferring the resulting toner image to paper. This printing operation is carried out by an electrostatic charger, an exposer, a developer, and a transfer device, and the series of processes is carried out during a single rotation of the photosensitive drum. An electrophotographic apparatus is further provided with a drum cleaner, between the transfer device and the electrostatic charger, for removing toner from the photosensitive drum so as to prevent any decrease in print quality that would otherwise be caused by the presence of unnecessary toner on the surface of the photosensitive drum after transfer to the paper. FIG. 6 illustrates an example of a conventional drum cleaner. This drum cleaner 100 comprises an arm 1 rotatably supported at its approximate middle, a cleaning blade 2 fixed to the distal end 1a of this arm 1, and a biasing means 3 connected to the arm 1.

The arm 1 is bent approximately in the middle, and the pivot 1c of the arm 1 is disposed at this bend portion. The cleaning blade 2 is formed in a flat shape from rubber or another such elastic material, and is pressed against the surface of the photosensitive drum D. The biasing means 3 attempts to rotate the arm 1 by exerting a biasing force on the proximal end 1b of the arm 1 in a direction intersecting this arm. As a result, the cleaning blade 2 is kept pressed against the surface of the photosensitive drum at a specific pressing force N, allowing any unnecessary toner clinging to the photosensitive drum D to be scraped off. The removed toner is brushed off the surface of the photosensitive drum D by a cleaning brush 9 provided adjacent to this drum cleaner 100.

With this drum cleaner 100, the cleaning blade 2 is disposed so as to be inclined in the rotational direction of the photosensitive drum D with respect to the radial direction of the photosensitive drum D, and the tilt angle θ of the cleaning blade 2 with respect to the surface of the photosensitive drum D (hereinafter referred to as the “cleaning angle θ”) is set within a specific angle range in order to prevent unnecessary toner from remaining on the photosensitive drum D due to the following problems. Specifically, if the cleaning angle θ is greater than a specific angle β, the distal end of the cleaning blade 2 will be subjected to excessive force, and the distal end of the cleaning blade 2 will curl locally. Repeated occurrence of this can damage the distal end of the cleaning blade 2. If the distal end of the cleaning blade 2 is thus damaged, this damaged portion will no longer be able to remove toner. On the other hand, if the cleaning angle θ is smaller than a specific angle α, the distal end of the cleaning blade 2 will attempt to curl over a relatively wide range, which will prevent the above-mentioned damage from occurring, but the contact surface area will increase between the cleaning blade 2 and the photosensitive drum D, so the contact pressure thereof will decrease, and as a result the toner cannot be effectively removed from the photosensitive drum D. Therefore, the cleaning angle θ is set at α<θ<β.

With this drum cleaner 100, however, the frictional force f between the cleaning blade 2 and the surface of the photosensitive drum D fluctuates, which can cause the arm 1 to rotate momentarily and allow the cleaning angle θ to go outside the angle range specified above.

More specifically, there is variance in the amount of toner clinging to the surface of the photosensitive drum D upon completion of transfer, so the above-mentioned frictional force f may fluctuate as the photosensitive drum D rotates. In specific terms, the frictional force f is larger when there is a small amount of toner clinging to the surface of the photosensitive drum D passing under the cleaning blade 2. When the frictional force f is thus larger, the cleaning blade 2 attempts to move along with the photosensitive drum D, and the arm 1 may rotate momentarily. If this happens, in this conventional example, the biasing force of the biasing means 3 decreases as the cleaning angle θ increases. As a result, the above-mentioned pressing force N begins decreasing, the cleaning blade 2 eventually comes to a stop once the cleaning angle θ becomes larger than the specific angle β, and the blade once again attempts to remove the toner on the photosensitive drum D. The result of this is that the distal end of the cleaning blade 2 may be damaged as mentioned above.

### SUMMARY OF THE INVENTION

The present invention has been proposed under the circumstances described above. It is, therefore, an object of the present invention to provide a drum cleaner with which it is possible to prevent damage to the toner-cleaning blade.

According to the present invention, there is provided a drum cleaner for removing unnecessary toner clinging to a photosensitive drum. The cleaner includes: an arm rotatable about an axis; a cleaning blade fixed to the arm and held in contact with the drum; a biasing member connected to the arm for holding the cleaning blade in pressing contact with drum; and an arm restrainer that prevents positional deviation of the arm resulting from fluctuation in a frictional force between the cleaning blade and the drum.

Preferably, the arm may include an intermediate portion corresponding in position to the axis mentioned above, a first end to which the cleaning blade is fixed, and a second end opposite to the first end. The biasing member is designed to exert a bias force on the arm in a direction intersecting the second end.

Preferably, the restrainer may include a cylinder, a piston disposed in the cylinder and working fluid contained in the cylinder. The piston is arranged to divide the cylinder into two chambers, while also being formed with an orifice causing the chambers to communicate with each other.

Preferably, the cleaner of the present invention may further include a shaft supporting the arm. The restrainer may include an elastic stopper that holds the arm in non-rotatable engagement with the shaft.

Preferably, the stopper may be formed with a slit coming into engagement with the arm, while also formed with a through-hole into which the shaft is fitted.

Preferably, the biasing member may be a first coil spring.

Preferably, the restrainer may include second and third coil springs exerting a bias force on the arm in opposite directions. The second and third coil springs have a spring constant greater than the spring constant of the first coil spring.

Preferably, the second and third coil springs may be located farther from the above-mentioned axis than the first coil spring is.

Preferably, the restrainer may include first and second walls spaced from each other, and a base bridging between the first and the second walls. In this case, the second coil spring may be disposed between the first wall and the arm, while the third coil spring between the second wall and the arm.

Preferably, the restrainer may further include a guide member held in slidable engagement with the base.

Other features and advantages of the present invention will become apparent from the detailed description given below with reference to the accompanying drawings.

### BRIEF DESCRIPTION OF THE DRAWINGS

FIG. 1 is a simplified side view of an example of an electrophotographic apparatus;

FIGS. 2A and 2B are a simplified side view of an example of the drum cleaner pertaining to the present invention;

FIG. 3 is a simplified side view of another example of the drum cleaner pertaining to the present invention;

FIG. 4 is a simplified perspective view, giving an enlarged detail view of the rotation control means in FIG. 3;

FIG. 5 is a simplified side view of another example of the drum cleaner pertaining to the present invention; and

FIG. 6 is a simplified side view of an example of a conventional drum cleaner.

### DETAILED DESCRIPTION OF THE PREFERRED EMBODIMENTS

Preferred embodiments of the present invention will be described below with reference to the accompanying drawings.

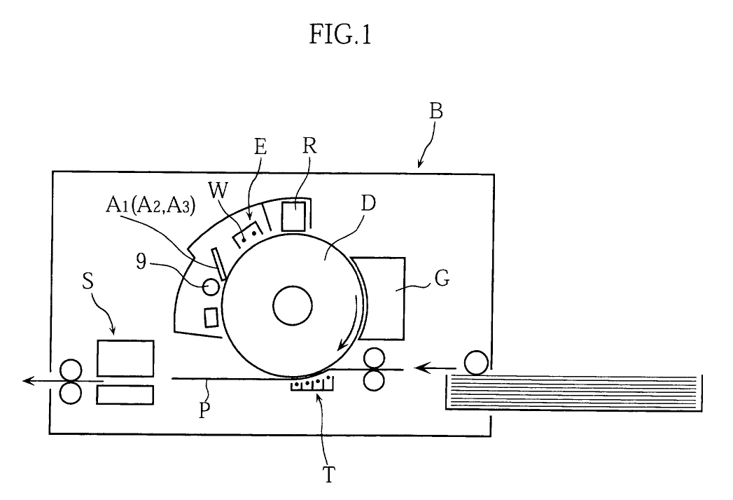

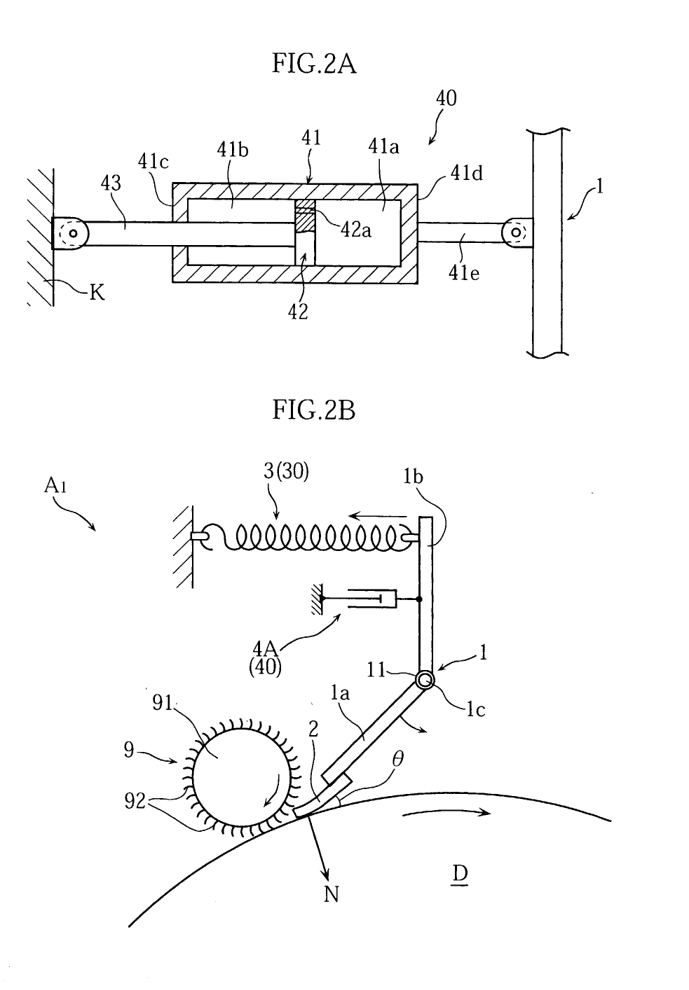

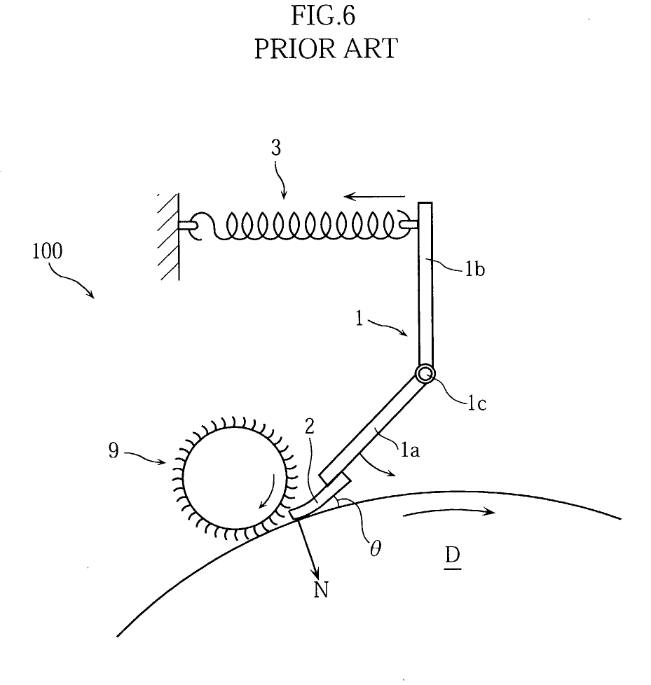

FIG. 1 is a simplified side view of an example of an electrophotographic apparatus, and FIG. 2B is a simplified side view of an example of the drum cleaner pertaining to the present invention. Those members, portions, etc., shown in FIG. 6, which illustrates a conventional example, are numbered the same in these drawings.

As shown in FIG. 1, a drum cleaner A1 is provided in order to remove unnecessary toner from the surface of a photosensitive drum D after transfer in an electrophotographic apparatus B constructed such that a toner image formed on the photosensitive drum D is transferred onto paper P. The electrophotographic apparatus B generally comprises the photosensitive drum D, an electrostatic charger E, an exposer R, a developer G, a transfer device T, and a fixer S. The drum cleaner A1 is disposed around the peripheral surface of the photosensitive drum D.

The photosensitive drum D is formed in a substantially cylindrical shape overall, and is designed to rotate at a specific speed. The photosensitive drum D has the property of losing its surface potential when the surface is irradiated with light, and is disposed in the electrophotographic apparatus B such that it is shielded from any external light.

The electrostatic charger E serves to charge the surface of the photosensitive drum D, and has on its inside, for example, a corona wire W composed of tungsten wire, disposed along the photosensitive drum D. During operation, a high voltage of approximately −6000 V is applied to the corona wire W, which induces corona discharge, and the surface of the photosensitive drum D is uniformly and negatively charged.

The exposer R is designed such that the desired site on the surface of the charged photosensitive drum D is irradiated with LED light, laser light, or the like. When the charged photosensitive drum D is exposed by this exposer R, the surface potential of the exposed portion of the photosensitive drum D is eliminated, which forms the desired electrostatic latent image.

The developer G is designed such that a fine power (toner) or the like is brought into contact with the surface of the photosensitive drum D on which the electrostatic latent image has been formed. Thus, the toner is made to adhere to the charged portion of the photosensitive drum D, that is, over the above-mentioned electrostatic latent image. As a result, the electrostatic latent image becomes a visible toner image on the surface of the photosensitive drum D.

The transfer device T is disposed facing the photosensitive drum D with the paper P therebetween, and is designed such that, for example, the paper is charged in the opposite polarity from that of the toner image, so that the toner image on the photosensitive drum D will be attracted and adhere to the paper P.

The fixer S is designed such that the toner transferred to the paper P is melted by a heating device (such as a hot roller or a xenon flash), and is then fixed on the paper P.

The drum cleaner A1 prevents any decrease in print quality that would otherwise be caused by the presence of unnecessary toner on the surface of the photosensitive drum D after transfer to the paper P, and is disposed between the transfer device T and the electrostatic charger E. As shown in FIG. 2B, the drum cleaner A1 comprises a rotatably supported arm 1, a cleaning blade 2 fixed to this arm 1, a biasing means 3 connected to the arm 1, and a rotation control means 4A. A cleaning brush 9 is provided next to the cleaning blade 2 on the transfer device T side.

The arm 1 is made from a metal or the like so as to have a specific rigidity, and is bent in its approximate middle. A pivot 1c of this arm 1 extends in the axial direction of the photosensitive drum D, and supports a bearing 11 provided to the bent portion of the arm 1.

The cleaning blade 2 is formed in a rectangular shape from rubber or another such elastic material, and is fixed to the distal end 1a of the arm 1. The length of the long side of the cleaning blade 2 corresponds to the length of the photosensitive drum D in its axial direction, and this long side presses against the surface (peripheral surface) of the photosensitive drum D. The cleaning blade 2 is disposed so as to be inclined with respect to the photosensitive drum D. The tilt angle θ of the cleaning blade 2 with respect to the surface of the photosensitive drum D (hereinafter referred to as the “cleaning angle θ”) is set to be greater than a specific angle α and less than a specific angle β.

The biasing means 3 is designed such that the biasing force thereof attempts to rotate the arm 1, which keeps the cleaning blade 2 pressed against the surface of the photosensitive drum D at a specific pressing force N. More specifically, the biasing means 3 is formed by a coil spring (first coil spring) 30 having a specific spring constant, and the coil spring 30 is disposed such that it exerts a biasing force on the proximal end 1b of the arm 1 in a direction intersecting this arm. This coil spring 30 acts to pull the proximal end 1b of the arm 1.

As best shown in FIG. 2A, the rotation control means 4A is formed by a damper 40 comprising a cylinder 41, the inside of which is filled in a sealed state with a compressible fluid; a piston 42 that divides the inside of the cylinder 41 into two chambers 41a and 41b; an orifice 42a that goes through the piston 42 so that these two chambers 41a and 41b communicate with each other; and a piston rod 43 that extends from this piston 42 and protrudes from one end 41c of the cylinder 41 to the outside of the cylinder 41. This damper 40 has a support rod 41e that extends from the other end 41d of the cylinder 41, and the distal end of the support rod 41e and the distal end of the piston rod 43 are swingably supported with respect to the proximal end 1b of the arm 1 and a fixing wall K inside the electrophotographic apparatus B. Therefore, when the arm 1 attempts to rotate, the damper 40 is subjected to a load in the axial direction of the piston rod 43.

With this damper 40, when the piston rod 43 is subjected to a load over a certain reference value (called “damper threshold” below) in the axial direction, passage of the fluid in the cylinder 41 through the orifice 42a is restricted, making it impossible for the piston 42 and the piston rod 43 to move. The fluid inside the cylinder is compressed at this point by the piston 42, which absorbs the load acting on the piston rod 43. On the other hand, when the piston rod 43 is subjected to a load under the predetermined damper threshold, passage of the fluid in the cylinder 41 through the orifice 42a is permitted, which allows the piston 42 and the piston rod 43 to move. The damper threshold can be varied as required by changing the number of orifices 42a and/or their opening surface area.

The damper threshold is determined depending upon a specific biasing force the spring 30 exerts when the cleaning blade 2 is pressed against the photosensitive drum D at the desired pressing force N. In the illustrated example, the damper threshold is greater than the specific biasing force in accordance with the principles of the lever and fulcrum. (Note that the point of action of the damper 40 with respect to the arm 1 is closer to the pivot 1c than the point of action of the spring 30 is.) Thus, even if the frictional force f fluctuates between the cleaning blade 2 and the surface of the photosensitive drum D, and the arm 1 attempts to rotate momentarily (as shown by an arrow in FIG. 2B) due to this fluctuation, the rotational force of the arm 1 will be absorbed by the damper 40, making it possible to maintain the orientation of the arm 1 as the photosensitive drum D rotates.

Upon application of a force below the damper threshold, on the other hand, the damper 40 allows the arm 1 to move. Thus, the new attachment or replacement of the spring 30, cleaning blade 2, etc., can be carried out easily with the damper 40 remaining in place.

The cleaning brush 9 has a body 91 formed in a substantially cylindrical shape overall, and brush bristles 92 protruding from the peripheral surface of this body 91. The length of the long side of the cleaning brush 9 is equal to the length of the long side of the cleaning blade 2, and this brush is disposed along the cleaning blade 2. The cleaning brush 9 is designed so as to rotate in the opposite direction from the photosensitive drum D.

Next, the action of the drum cleaner A1 having the above structure will be described.

As the photosensitive drum D rotates, printing is successively performed on its surface. More specifically, first an electrostatic latent image is formed on the surface of the photosensitive drum D by the electrostatic charger E and the exposer R, and then toner is made to adhere to the electrostatic latent image by the developer G. The toner image thus obtained is transferred to the paper P by the transfer device T, after which the paper P is conveyed to the fixer S, where the toner image is fixed to the surface of the paper.

Meanwhile, untransferred toner may cling to the surface of the photosensitive drum D in the area that has already undergone transfer, and is therefore cleaned away by the drum cleaner A1 as follows so as to avoid the drop in print quality that would occur if the printing process were carried out through the next print cycle in this state.

Specifically, since the biasing force of the biasing means 3 attempts to rotate the arm 1, the cleaning blade 2 is kept pressed against the surface of the photosensitive drum D at the specified pressing force N. As a result, when the cleaning blade 2 passes over the above-mentioned area, any toner on the photosensitive drum D is scraped off by the cleaning blade 2. The loosened toner is swept away from the surface of the photosensitive drum D by the rotation of the cleaning brush 9.

At this point the cleaning blade 2 is bent by the pressing force N, and is inclined at a specific cleaning angle θ, which is set at α<θ<β. As noted above, if the cleaning angle θ is no greater than α, a decrease in contact pressure between the cleaning blade 2 and the photosensitive drum D will be caused by a larger contact surface area between these two, so the toner on the photosensitive drum D cannot be effectively removed. If the angle θ is no smaller than β, the distal end of the cleaning blade 2 will be damaged by repeated local bending of the cleaning blade 2 due to excessive force being applied to the distal end.

Also, as mentioned above, the cleaning blade 2 is disposed so as to be inclined with respect to the photosensitive drum D. This means that the resistance encountered by the cleaning blade 2 as it removes the toner is made to act in along the direction of the cleaning blade 2. Thus, the orientation of the cleaning blade 2 can be maintained against this resistance, and therefore there is no change in the cleaning angle θ.

A frictional force f is produced here between the cleaning blade 2 and the surface of the photosensitive drum D, and this frictional force f fluctuates with the amount of toner adhering to the above-mentioned area. More specifically, the frictional force f tends to increase in inverse proportion to the amount of toner adhering to the area. When this frictional force f is large, the cleaning blade 2 (and hence the arm 1) would be moved (without any countermeasures) along with this area, causing the cleaning angle θ to increase. With the drum cleaner A1, however, the damper 40 absorbs the rotational force of the arm 1, and the rotational orientation of the arm 1 is maintained. Therefore, damage to the distal end of the cleaning blade 2 can be prevented.

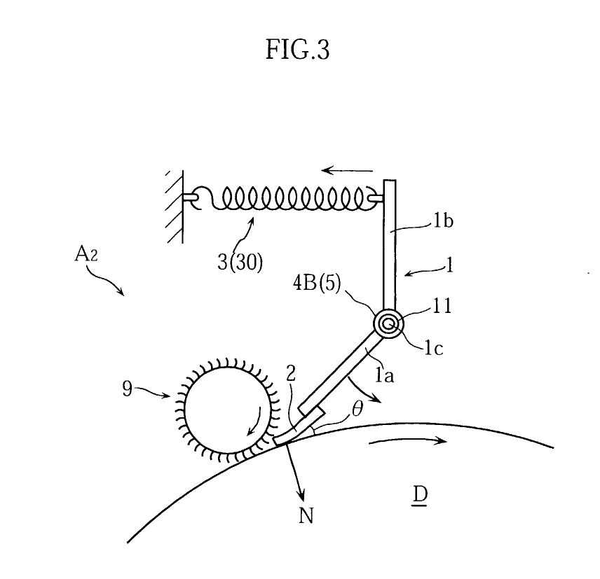

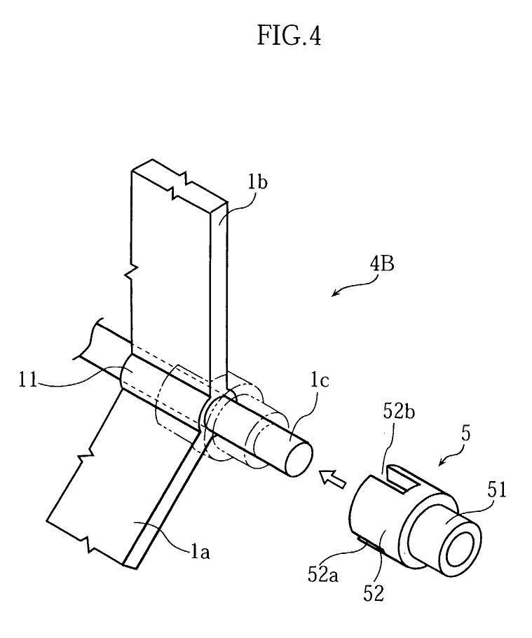

FIG. 3 is a simplified side view of a drum cleaner according to a second embodiment of the present invention, and FIG. 4 is a simplified perspective view, giving an enlarged detail view of the rotation control means in FIG. 3. In these drawings, those elements that are the same as or similar to those in the previous embodiment (the drum cleaner A1) are numbered the same as in the previous embodiment.

The drum cleaner A2 shown in FIG. 3 is equipped with a rotation control means 4B instead of the rotation control means 4A, and differs from the drum cleaner A1 in this respect. This rotation control means 4B is formed by an elastic member or stopper 5 fitted non-rotatably with respect to both the pivot 1c of the arm 1 and the bearing 11 of the arm 1.

As shown in FIG. 4, the stopper 5 is integrally formed from rubber or another material having the specified elasticity, and comprises a cylindrical first end 51 and a second end 52 that is cylindrical overall and communicates with the first end 51. The first end 51 is formed such that its inside diameter is slightly smaller than the outside diameter of the pivot 1c of the arm 1. The second end 52 is formed such that its inside diameter is slightly larger than the outside diameter of the bearing 11 of the arm 1, and the distal end 1a and proximal end 1b of the arm 1 have notches 52a and 52b, respectively. The notches 52a and 52b are formed so that they extend from the end face of the second end 52 toward the first end 51, and the width of each is equal to the thickness of the distal end 1a and the proximal end 1b of the arm 1.

The stopper 5 is designed such that the distal end 1a of the arm 1 and the proximal end 1b engage in the notches 52a and 52b while the second end 52 fits onto the bearing 11 of the arm 1, and the first end 51 fits over the pivot 1c of the arm 1. As a result, the stopper 5 is non-rotatable with respect to both the pivot 1c of the arm 1 and the bearing 11 of the arm 1. This means that when the cleaning blade 2 removes toner from the photosensitive drum D, if the frictional force f becomes so large that the arm 1 attempts to rotate momentarily so as to increase the cleaning angle θ, the rotational force of the arm 1 will be absorbed by the elasticity of the stopper 5, allowing the rotational orientation of the arm 1 to be maintained. Therefore, damage to the distal end of the cleaning blade 2 can be prevented.

Also, since the stopper 5 is formed from rubber or the like, it can be formed easily and inexpensively by molding in a metal mold, for example. This drum cleaner A₂ can therefore be manufactured at a lower cost. Also, since the rotation control means 4B require no other member besides the stopper 5, which has a simple shape as discussed above, the drum cleaner A₂ can be kept from becoming large and complex.

The stopper 5 is attached in a state in which the rotational orientation of the arm 1 (and the biasing force of the biasing means 3) presses the cleaning blade 2 against the surface of the photosensitive drum D at a specific pressing force N, and this keeps the pressing force N constant. Also, with the stopper 5, the first end 51 is fitted over the pivot 1c of the arm 1 and is non-rotatable with respect to this pivot 1c. According to the present invention, the first end 51 may be made non-rotatable by providing a key between the pivot 1c of the arm 1 and the first end 51.

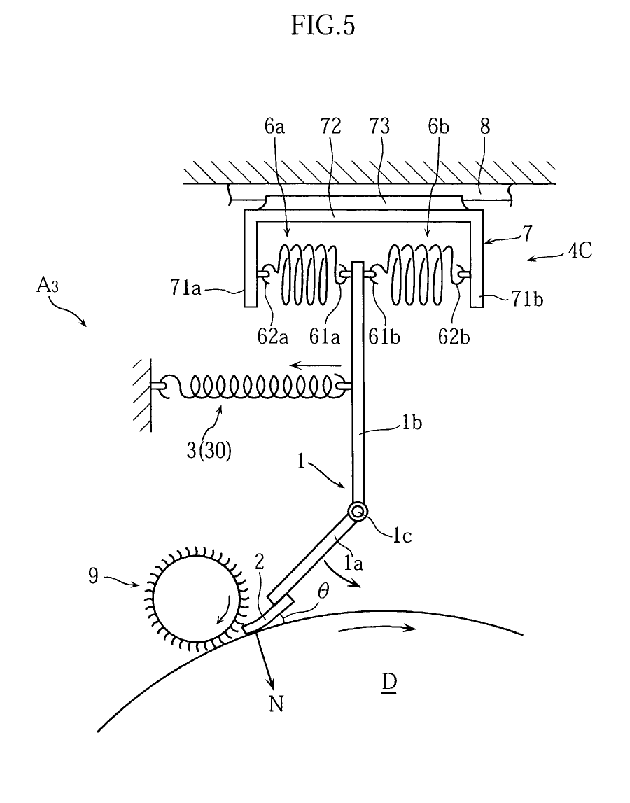

FIG. 5 is a simplified side view of a drum cleaner according to a third embodiment of the present invention. In this drawing, those elements that are the same as or similar to those in the previous embodiment (the drum cleaners A₁ and A₂) are numbered the same as in the previous embodiments.

The drum cleaner A3 shown in FIG. 5 is equipped with a rotation control means 4C instead of the rotation control means 4A or 4B, and differs from the drum cleaners A1 and A2 in this respect. This rotation control means 4C has a frame 7 formed from metal or the like, and a pair of second coil springs 6a and 6b that act on the proximal end 1b of the arm 1 in mutually opposite directions along an intersecting direction that intersects this arm 1.

The frame 7 serves to support the second coil springs 6a and 6b, and has a pair of walls 71a and 71b disposed apart from each other in the above-mentioned intersecting direction, and a base wall 72 from which the ends of the pair of walls 71a and 71b are hung. A slider 73 that is able to move back and forth over a rail 8 for moving the frame 7 in the intersecting direction is fixed to the bottom of the base wall 72, and this slider 73 (frame 7) is designed such that it can be fixed in a stationary state on the rail 8 by a screw or the like (not shown).

The second coil springs 6a and 6b are formed such that their spring constant is greater than that of the first coil spring 30, and the respective ends (connected ends) 61a and 61b thereof are connected to the proximal end 1b of the arm 1. The fixed ends 62a and 62b of the second coil springs 6a and 6b (the opposite ends from the connected ends 61a and 61b) are supported on the frame 7 by being respectively fixed to the pair of walls 71a and 71b.

When the rotation control means 4C is attached, first, in a state in which the frame 7 is able to move over the rail 8, a state is created in which the rotational orientation of the arm 1 (and the biasing force of the biasing means 3) will press the cleaning blade 2 against the surface of the photosensitive drum D at the specific pressing force N. In this state, the frame 7 should be fixed to the rail 8 so as to be supported in a stationary state.

As mentioned above, this rotation control means 4C is such that the second coil springs 6a and 6b, which have a larger spring constant than the first coil spring 30, act on the proximal end 1b of the arm 1 in mutually opposite directions along an intersecting direction that intersects this arm. If the arm 1 should attempt to rotate momentarily so as to increase the cleaning angle θ, the rotational force of this arm 1 will be absorbed by the elastic force of the second coil springs 6a and 6b, and the rotational orientation of the arm 1 can be maintained. Therefore, damage to the distal end of the cleaning blade 2 can be prevented.

Naturally, the present invention is not limited to the embodiments given above, and all design modifications within the scope of the claims are encompassed by the present invention.

As described above, with the drum cleaners A1, A2, and A3 according to the present invention, the rotation control means 4A, 4B, and 4C can absorb the force by which fluctuations in the above-mentioned frictional force f attempt to rotate the arm 1 momentarily. Thus, the rotational orientation of the arm 1 can be maintained, and changes in the cleaning angle θ can be prevented. Therefore, damage to the distal end of the cleaning blade 2 can be prevented, which is advantageous to effective removal of toner from the photosensitive drum D.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. A drum cleaner for removing unnecessary toner clinging to a photosensitive drum, the cleaner comprising:
an arm rotatable about an axis;
a cleaning blade fixed to the arm and held in contact with the drum;
a biasing member connected to the arm for holding the cleaning blade in pressing contact with drum; and
an arm restrainer that prevents positional deviation of the arm resulting from fluctuation in a frictional force between the cleaning blade and the drum.

2. The cleaner according to claim 1, wherein the arm includes an intermediate portion corresponding in position to said axis, a first end to which the cleaning blade is fixed, and a second end opposite to the first end, the biasing member being designed to exert a bias force on the arm in a direction intersecting the second end.

3. The cleaner according to claim 1, wherein the restrainer includes a cylinder, a piston disposed in the cylinder and working fluid contained in the cylinder, the piston being arranged to divide the cylinder into two chambers and formed with an orifice causing the chambers to communicate with each other.

4. The cleaner according to claim 1, further comprising a shaft supporting the arm, wherein the restrainer comprises an elastic stopper that holds the arm in non-rotatable engagement with the shaft.

5. The cleaner according to claim 4, wherein the stopper is formed with a slit coming into engagement with the arm and a through-hole into which the shaft is fitted.

6. The cleaner according to claim 1, wherein the biasing member comprises a first coil spring.

7. The cleaner according to claim 6, wherein the restrainer comprises second and third coil springs exerting a bias force on the arm in opposite directions, the second and third coil springs having a spring constant greater than a spring constant of the first coil spring.

8. The cleaner according to claim 7, wherein the second and third coil springs are farther from said axis than the first coil spring is.

9. The cleaner according to claim 7, wherein the restrainer comprises first and second walls spaced from each other, and a base bridging between the first and the second walls, the second coil spring being disposed between the first wall and the arm, the third coil spring being disposed between the second wall and the arm.

10. The cleaner according to claim 9, wherein the restrainer further comprises a guide member held in slidable engagement with the base.
